(19) United States
(12) Patent Application Publication
(10) Pub. No.: US 2026/0332966 A1
(43) Pub. Date: Oct. 22, 2026

(54) SYSTEMS AND METHODS FOR MEMS-BASED VOICE ACCELEROMETER DEVICES

(71) Applicant: Nanusens SL, Cerdanyola del Vallès (ES)

(72) Inventors: Marco Antonio Llamas Morote, Cerdanyola del Vallès (ES); Thomas Hanley, London (GB)

(73) Assignee: Nanusens SL, Cerdanyola del Vallès (ES)

(21) Appl. No.: 19/651,909

(22) Filed: Apr. 20, 2026

Related U.S. Application Data
(60) Provisional application No. 63/791,175, filed on Apr. 18, 2025.

(51) Int. Cl. H04R 19/04; H04R 31/00

(52) U.S. Cl. CPC H04R 19/04; H04R 31/006; H04R 2201/003

(57) ABSTRACT

A MEMS or NEMS-based voice accelerometer including a sensing rotor having one or more apices forming a proof mass suspended by one or more distal springs, where each of the one or more apices including plurality of fingers and each of the fingers including a plurality of apices teeth. The accelerometer includes a sensing stator having one or more stationary electrodes with a plurality of electrode teeth that are interdigitated with the plurality of apices teeth.

### CROSS-REFERENCE TO RELATED APPLICATIONS

This application claims priority to and the benefit of US Provisional Application No. 63/791,175, filed on Apr. 18, 2025, and entitled “MEMS-BASED VOICE ACCELEROMETER DEVICES,” the entire contents of which are incorporated herein by reference.

### TECHNICAL FIELD

The present disclosure relates to semiconductor devices and, more particularly, to MEMS-based accelerometer devices.

### BACKGROUND

Voice accelerometers (also known as bone conduction sensors) require a single-axis accelerometer implantation to detect vibration due to sound waves transmitted through the skull during speech. Typical applications include: earbuds and headphones, background noise and wind suppression, auto-mute, voice activity detection, tap detection and voice commands. Voice accelerometers have also applicability to industrial and automotive applications such as predictive maintenance, among others.

### SUMMARY

The application, in various implementations provides systems and methods having technical advantages and benefits of NNS MEMS-in-CMOS implementations of a voice accelerometer.

Various implementations include fabrication of a MEMS device via the back-end metal layers of any solid state or semiconductor process including, for example, a CMOS process. Fabrication may include, for example, compound processes, like GaAs, GaN and SiGe among others without limitation. In all these cases etching may be performed with vHF or other techniques as a post-processing vHF etching. However, etching processes other than vHF may be used for MEMS capacitive switching devices and systems disclosed herein. Also, MEMS-based voice accelerometer devices may be built and/or fabricated using MEMS manufacturing processes other than vHF etching. For example, MEMS-based voice accelerometer may may be formed by building a MEMS process with a large number of structural layers and then implementing the devices. Various implementations also include MEMS-based voice accelerometer devices configured to withstand electrostatic discharge (ESD).

In one aspect, a MEMS or NEMS-based voice accelerometer includes a sensing rotor having one or more apices forming a proof mass suspended by one or more distal springs, where each of the one or more apices including plurality of fingers and each of the fingers including a plurality of apices teeth. The accelerometer includes a sensing stator having one or more stationary electrodes with a plurality of electrode teeth that are interdigitated with the plurality of apices teeth.

At least one of the plurality of apices teeth, plurality of fingers and one or more apices may include multiple metal and/or via layers to increase a mass of the proof mass. The voice accelerometer may be connected to at least one more voice accelerometers in parallel to form an array of CMOS NEMS transducers.

The voice accelerometer may include a compensation stator, being isolated from the one or more stationary sensing stator electrodes, configured to be driven independently or configured to be implemented on a rotor-stator pair also used for sensing. The voice accelerometer may be connected to at least a second accelerometer in parallel to form an array of CMOS MEMS or NEMS transducers.

The voice accelerometer may include a gap positioned between the sensing stator and at least one of the plurality of apices teeth. The size of the gap may be set and/or configured to set a slide film dampening to a level for critical damping or underdamping. The number of apices may be proportional to a size of a proof mass. The voice accelerometer may be included in an array of transducers such that when a number of transducers within the array are doubled, a signal-to-noise ratio associated with the array is increased by greater than or equal to 3dB. The voice accelerometer may electrically connected to at least a second voice accelerometer.

In another aspect, an integrated circuit includes a first accelerometer as described above oriented along a first axis and a second accelerometer as described above oriented along a second axis orthogonal to the first axis. The integrated circuit may include a third accelerometer as described above in a third axis orthogonal to both the first axis and second axis.

The integrated circuit may include a gap positioned between the sensing stator and at least one of the plurality of apices teeth of a voice accelerometer. The integrated circuit may include a size of the gap that is configured to set a slide film dampening to a level for one of critical damping and underdamping. The number of apices may be proportional to a size of a proof mass.

The integrated circuit may be included in or have an array of transducer circuits such that when a number of transducers within the array are doubled, a signal-to-noise ratio associated with the array is increased by about 3dB. The integrated circuit includes at least a second voice accelerometer device. The integrated circuit may include one or more electrodes for offset compensation of asymmetries in one or more gaps between the sensing stator and at least one of the plurality of apices teeth. The one or more electrodes may include rotor-stator couples where the stator is isolated from sensing stator electrodes and driven independently.

In another aspect, a method for manufacturing a NEMS or MEMS-based voice accelerometer includes forming a sensing rotor including forming a proof mass suspended by one or more distal springs using one or more apices, where each of the one or more apices has a plurality of fingers and each of the fingers including a plurality of apices teeth; and forming a sensing stator including one or more stationary electrodes having a plurality of electrode teeth that are interdigitated with the plurality of apices teeth.

A reading of the following detailed description and a review of the associated drawings will make apparent the advantages of these and other structures. Both the foregoing general description and the following detailed description serve as an explanation only and do not restrict aspects of the disclosure as claimed.

### BRIEF DESCRIPTION OF THE DRAWINGS

Reference to the detailed description, combined with the following figures, will make the disclosure more fully understood, wherein:

FIG. 1 shows a diagram of an in-plane according to an implementation of the disclosure;

FIG. 2 shows an exemplary exploded view of a MEMS-based device according to an implementation of the disclosure; and

FIG. 3 shows a process for manufacturing an IC including an voice accelerometer device according to an implementation of the disclosure.

### DETAILED DESCRIPTION

In the following description, like components have the same reference numerals, regardless of different illustrated implementations. To illustrate implementations clearly and concisely, the drawings may not necessarily reflect appropriate scale and may have certain structures shown in somewhat schematic form. The disclosure may describe and/or illustrate structures in one implementation, and in the same way or in a similar way in one or more other implementations, and/or combined with or instead of the structures of the other implementations.

In the specification and claims, for the purposes of describing and defining the invention, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “comprise,” “include,” and/or plural forms of each, include the listed parts and can include additional parts not listed, while terms such as “and/or” include one or more of the listed parts and combinations of the listed parts. Use of the terms “top,” “bottom,” “above,” “below” and the like helps only in the clear description of the disclosure and does not limit the structure, positioning and/or operation of the disclosure in any manner.

### Implementation 1 – High-Q, High-Sensitivity Mechanical Design for a Low Noise Voice Accelerometer (e.g., Bone Conduction or Vibration Sensor) utilizing Single-Axis NEMS Accelerometer Mechanical Architecture

Certain aspects of the present disclosure describe an illustrative High-Q, High-Sensitivity Mechanical Design for a Low Noise Voice Accelerometer (a.k.a Bone Conduction or Vibration Sensor) Utilising Single-Axis NEMS Accelerometer Mechanical Architecture Transducer SNR is critical to achieving a high SNR sensor. Damping of the MicroElectroMechanical/NanoElectroMechanical (MEMS/NEMS) or Micro or nanoelectrolmechanical (M/NEMS) device within the accelerometer converts to electrical noise in the transduction process and acts as input noise to the electrical sensing circuitry. A high-Q mechanical design reduces this input noise enabling a higher SNR sensor.

The dominant noise source in the MEMS/NEMS device is gas-damping. The primary contributor to gas-damping in MEMS/NEMS devices is squeeze-film damping. This implementation presents an architecture where squeeze-film damping is eliminated leaving the dominant damping source as slide-film damping, which is shown to present a greatly reduce resistance to motion leading to a higher-Q device.

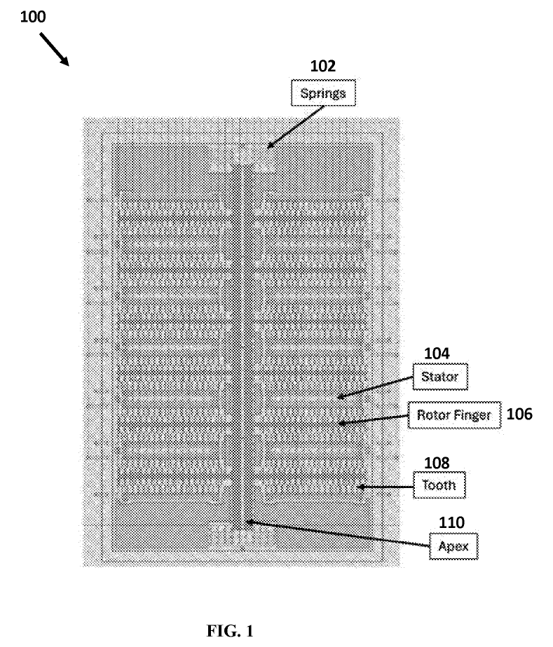

FIG. 1 shows a diagram of an in-plane voice acceleration device 100. The device 100 architecture constitutes an in-plane displacement accelerometer featuring one or multiple apices 110 suspended by distal springs 102 and populated with multiple rotor fingers 106 with protruding teeth 108. The teeth 108 are interdigitated with teeth on one/multiple stationary electrodes and/or stators 104. Multiple apices, e.g., apex 110, may be employed to increase the proof mass, increasing device 100 sensitivity. The teeth 108, fingers 106, and apices 110 can use multiple metal and via layers to increase the proof mass.

The use of an interdigitated in-plane architecture of device 100 allows for key features for noise reduction. Firstly, a large gap between rotor 106/stator 104 teeth tips and the opposing stator/rotor beam is maintained in order to reduce squeeze film damping to a negligible level. This leaves slide film damping as the dominant dissipation source. The interdigitated gap between teeth is increased/decreased to tune the slide film damping to a level that is desired for either critical damping or underdamping depending on the device 100 requirements and packaging.

### Implementation 2 – CMOS NEMS Transducer Arrays for a High-SNR Voice Accelerometer

The device of implementation 1 described above may be miniaturized in order to increase the manufacturability and robustness at the expense of sensitivity. In this instance, the device may be connected to several other devices in parallel to form an array of CMOS NEMS transducers. Whilst the manufacturability and robustness improvements are retained the signal-to-noise ratio (SNR) is improved by 3dB each time the number of cells in the array is doubled. This can enable the SNR specification to be met using low sensitivity, but robust and reliable, devices. Implementation 3 – MEMS Trim Architecture for Voice Accelerometer

The manufacturing tolerance of a MEMS or CMOS process can lead to asymmetries in the gaps present in the MEMS accelerometer of implementation 1. IF the device is, for example, a differential device, it is important that these asymmetries can be tuned out. Implementation 3 is for the implementation and use of one or more electrodes for device offset compensation. These electrodes can be formed by rotor-stator couples where the stator, known as compensation stator, is isolated from sensing stator electrodes and can be driven independently or this can be implemented on a rotor-stator pair also used for sensing. The compensation rotor will be attached to the device proof mass. The compensation stator can be controlled by an integrated ASIC on a closed loop architecture. Device offset compensation can be achieved by using a corresponding voltage to generate corresponding electrostatic force between the compensation stator and compensation rotor to correct the device offset. This could also be achieved by applying a DC offset to the sense rotor-stator pair.

### Additional Implementation – CMOS Integrated 3-Axis Accelerometer

The device 100 of implementation 1 or implementation 2 may be combined with an identical device placed on the chip in an orthogonal orientation to produce a 2-axis accelerometer. Further to this, the 2-axis accelerometer may be combined with an out-of-plane accelerometer to produce an integrated 3-axis accelerometer.

Within this application, we will use the term “inertial sensor” to refer to a variety of devices that sense acceleration. This may include at least an accelerometer, a motion detector and a bone conduction sensor. Their physical principle of operation is the same, but their difference is in the frequencies that they detect. So their bandwidth and whether they need to sense direct current (DC) or not, and also their resolution and/or sensitivity requirements.

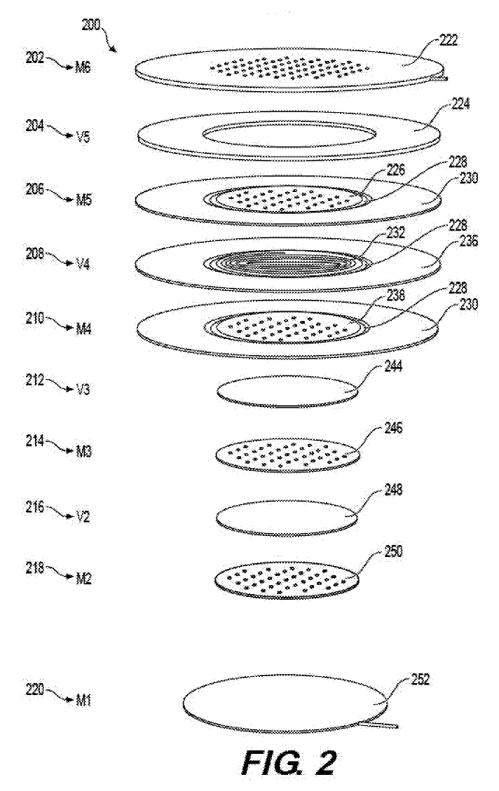

FIG. 2 is an exploded view of the metal and via layers of a MEMS device 200 without showing the SiO2, passivation, and substrate that may implement a voice accelerometer. FIG. 2 describes an out-of-plane inertial sensor. It is built using a 6 metal BEOL CMOS process. Metal layers are numbered M1 (bottom) to M6 (top). There are 5 via layers, numbered V1 (between M1 and M2) up to V5 (between M5 and M6), although V1 is not used in this particular design. The proof mass has a circular structure, it has three spiral springs evenly placed around it, and the diameter of the proof mass plus the springs is 50µm. The proof mass is made with a stack-up of metal layers M2 to M5, and the springs stacking up metal layers M4 and M5. The proof mass has concentric rings, stopped at the etching holes that go vertically across it, made with via layers V2 to V4.

The top metal plane has the same diameter plus an external ring of 20µm width around it, which is equivalent of a circle having 90µm of diameter. There is an array of 0.8µm holes spaced approximately 5µm between the center of each two holes in both X and Y directions. The springs have a surrounding ring of 20µm width around them, built on the same layers M4 and M5. There is an array of concentric vias joining these rings and the top metal plane on these rings. That is, they are implemented at layers V4 and V5.

There is a circular bottom metal plane made with M1, with a diameter of also 50µm plus an exterior ring of 6µm width, so smaller than the external rings of the top layers for the top metal plane and the support of the springs. Together the internal circle and the external ring are equivalent to a circle of 62µm diameter. The difference between the internal circle and the external ring comes from the fact that after the vHF etching, the external ring is partially etched and the edges keep buried (and subjected) to the silicon oxide. The top passivation is opened with a circular shape of 50µm, which is above the MEMS device.

MEMS device 200 includes M6 layer 202, V5 layer 204, M5 layer 206, V4 layer 208, M4 layer 210, V3 layer 212, M3 layer 214, V2 layer 216, M2 layer 218, and M1 layer 220. M6 layer 202 includes a top plate 222 with etching holes arranged in an array and a connection to an ASIC. V5 layer 204 includes an array of concentric via rings 224 extending over the outer metal. M5 layer 206 includes a proof mass top lid 226 with array of etching holes. Layer 206 also includes a portion of spiral springs 228 and an outer metal ring 230. V4 layer 208 includes array 232 of concentric via rings extending over the outer metal, a portion of the spiral springs 228 that extends in the V4 layer 208, and array 236 of concentric via rings extending over the proof mass and stopping at the etching hole locations while surrounding the hole locations with square rings. M4 layer 210 includes a proof mass plane 238 with an etching hole array, a portion of spiral springs 228, and a portion of outer metal ring 230. V3 layer 212 includes an array of concentric via rings 244 extending over the proof mass and stopping at the etching hole locations while surrounding the hole locations with square rings. M3 layer 214 includes proof mass metal plane 246 with an etching hole array. V2 layer 216 includes an array 248 of concentric via rings extending over the proof mass, stopping at the etching hole locations and surrounding them with square rings. M2 layer 218 include proof mass metal bottom lid 250 including an etching hole array. M1 layer 220 includes bottom metal plane 252 including a connection to an ASIC.

A preferred implementation for an accelerometer, using a 6 metal layer process, where M1 layer 220 is the bottom layer and M6 layer 202 is the top one, would be as follows. M1 layer 220 would be used to implement the bottom plane and M6 layer 202 the top metal plane, which would be shorted to the proof mass and springs. The proof mass would be implemented using a stack-up of M2 layer 218 to M5 layer 206. And the springs 228 would be implemented using either only M5 layer 206 or a stack-up of M4 layer 210 and M5 layer 206.

If we set the total diameter of the proof mass plus the springs, then there is an optimum for the length or maximum angle that the springs rotate. Longer springs (longer total angle) means that they will be softer, but the proof mass will be smaller. Shorter springs will allow for a larger proof mass but the springs will be stiffer. Therefore there is always an optimum, which will depend on the specific design and process properties. In general however it is difficult to build reliable devices and with good yield with springs having angles of more than 360°. That is, preferably each individual spring will not complete a turn around the circular proof mass.

Another parameter that affects design yield, performance and reliability is the spacing around the springs. That is, the horizontal spacing or gap existing at each point of the springs without any other spring, proof mass, anchor or any part of the device (except at the edges of the spring, as they start and end up being fused with the outer ring or anchor/wall and the proof mass or other MEMS part). This obviously needs to be at least equal to the minimum spacing set by the process design rule checking (DRC). However in practice we will set it to a higher value, between x2 and x10 of this minimum spacing set by the DRC of the process. A preferred value is x5. For instance with a 180nm process having a minimum gap DRC between metals of 300nm, we will preferably set this horizontal spacing for the springs as 1.5µm. The trade-off here is that for very large spacing we will reduce sensitivity and/or performance, because we will reduce more the proof mass area and hence mass for the same spring length (hence to achieve a given softness/stiffness for the springs). But reducing this horizontal spacing between the springs it will lead to poor yield and reliability.

Another key aspect of the springs, especially important when they are soft, such as in the case when we use a set of three or more spiral springs evenly distributed around a central proof mass, is to make them short enough, compared to the displacement (both vertical, so out-of-plane, and horizontal, so in-plane). Since we have small proof mass and we want very soft springs in order to achieve enough sensitivity, this would in principle be prone to stiction issues, which would lead to very poor reliability for these MEMS devices.

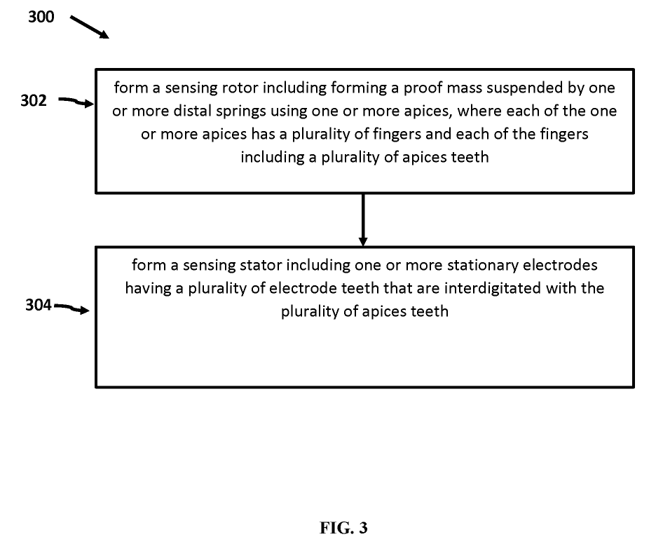

FIG. 3 shows a process 300 for fabricating a voice accelerometer device according to an implementation of the disclosure. Process 300 includes: forming a sensing rotor including forming a proof mass suspended by one or more distal springs using one or more apices, where each of the one or more apices has a plurality of fingers and each of the fingers including a plurality of apices teeth (Step 302); and forming a sensing stator including one or more stationary electrodes having a plurality of electrode teeth that are interdigitated with the plurality of apices teeth (Step 304).

In various implementations, an voice accelerometer device may be implemented for a MEMS device or an IC device (e.g., only ASIC and no MEMS). Elements of different implementations described may be combined to form other implementations not specifically set forth previously. Elements may be left out of the systems described previously without adversely affecting their operation or the operation of the system in general. Furthermore, various separate elements may be combined into one or more individual elements to perform the functions described in this specification.

1. A MEMS or NEMS-based voice accelerometer comprising:
a sensing rotor including one or more apices forming a proof mass suspended by one or more distal springs, each of the one or more apices including plurality of fingers, each of the fingers including a plurality of apices teeth; and
a sensing stator including one or more stationary electrodes including a plurality of electrode teeth that are interdigitated with the plurality of apices teeth.

2. The voice accelerometer of claim 1, wherein at least one of the plurality of apices teeth, plurality of fingers and one or more apices include multiple metal or via layers to increase a mass of the proof mass.

3. The voice accelerometer of claim 1, wherein the voice accelerometer is connected to at least one more voice accelerometers in parallel to form an array of CMOS NEMS transducers.

4. The voice accelerometer of claim 1 comprising a compensation stator, being isolated from the one or more stationary sensing stator electrodes, configured to be driven independently or configured to be implemented on a rotor-stator pair also used for sensing.

5. The voice accelerometer of claim 1, wherein the accelerometer is connected to at least a second accelerometer in parallel to form an array of CMOS MEMS or NEMS transducers.

6. The voice accelerometer of claim 1 comprising a gap positioned between the sensing stator and at least one of the plurality of apices teeth.

7. The voice accelerometer of claim 6, wherein a size of the gap is set to set a slide film dampening to a level for one of critical damping and underdamping.

8. The voice accelerometer of claims 1 wherein a number of apices is proportional to a size of a proof mass.

9. The voice accelerometer of claim 1 comprising including the voice accelerometer in an array of transducers such that when a number of transducers within the array are doubled, a signal-to-noise ratio associated with the array is increased by about 3dB.

10. The voice accelerometer of claim 1, wherein the voice accelerometer is connected to at least a second voice accelerometer.

11. An integrated circuit comprising:
a first accelerometer oriented in a first axis including:
a first sensing rotor including one or more apices forming a proof mass suspended by one or more distal springs, each of the one or more apices including plurality of fingers, each of the fingers including a plurality of apices teeth; and
a first sensing stator including one or more stationary electrodes including a plurality of electrode teeth that are interdigitated with the plurality of apices teeth; and
a second accelerometer oriented in a second axis orthogonal to the first axis including:
a second sensing rotor including one or more apices forming a proof mass suspended by one or more distal springs, each of the one or more apices including plurality of fingers, each of the fingers including a plurality of apices teeth; and
a second sensing stator including one or more stationary electrodes including a plurality of electrode teeth that are interdigitated with the plurality of apices teeth.

12. The integrated circuit of claim 11 comprising:
a third accelerometer oriented in a third axis orthogonal to both the first axis and second axis including:
a third sensing rotor including one or more apices forming a proof mass suspended by one or more distal springs, each of the one or more apices including plurality of fingers, each of the fingers including a plurality of apices teeth; and
a third sensing stator including one or more stationary electrodes including a plurality of electrode teeth that are interdigitated with the plurality of apices teeth.

13. The integrated circuit of claim 11 comprising a gap positioned between the sensing stator and at least one of the plurality of apices teeth.

14. The integrated circuit of claim 11, wherein a size of the gap is set to set a slide film dampening to a level for one of critical damping and underdamping.

15. The integrated circuit of claim 11, wherein a number of apices is proportional to a size of a proof mass.

16. The integrated circuit of claim 11 comprising including the integrated circuit in an array of transducer circuits such that when a number of transducers within the array are doubled, a signal-to-noise ratio associated with the array is increased by about 3dB.

17. The integrated circuit of claims 11, wherein the integrated circuit includes at least a second voice accelerometer device.

18. The integrated circuit of claim 11 comprising one or more electrodes for offset compensation of asymmetries in one or more gaps between the sensing stator and at least one of the plurality of apices teeth.

19. The integrated circuit of claim 18, wherein the one or more electrodes by rotor-stator couples where the stator is isolated from sensing stator electrodes and driven independently.

20. A method for manufacturing a NEMS or MEMS-based voice accelerometer comprising:
forming a sensing rotor including forming a proof mass suspended by one or more distal springs using one or more apices, each of the one or more apices including plurality of fingers, each of the fingers including a plurality of apices teeth; and
forming a sensing stator including one or more stationary electrodes having a plurality of electrode teeth that are interdigitated with the plurality of apices teeth.
